(19) United States
(12) Patent Application Publication
(10) Pub. No.: US 2002/0047613 A1
(43) Pub. Date: Apr. 25, 2002

(54) Xenon flash light source apparatus, socket for xenon flash light source apparatus, and rectifier apparatus

(75) Inventors: Yuji Shimazu, Hamamatsu-shi (JP); Makoto Miyamoto, Hamamatsu-shi (JP); Yuichi Yamashita, Hamamatsu-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 09/951,477

(22) Filed: Sep. 14, 2001

Related U.S. Application Data
(63) Continuation-in-part of application No. PCT/JP00/01581, filed on Mar. 15, 2000.

(30) Foreign Application Priority Data
Mar. 15, 1999 (JP) P1999-068580

(51) Int. Cl. H05B 39/00

(52) U.S. Cl. 315/246; 315/185 R

(57) ABSTRACT

While a power supply line from a main power section to a light-emitting section in a xenon flash lamp is provided with a diode in order to prevent a current from flowing into the main power section, there has been a problem that the diode generates heat due to a large current passing therethrough upon power supply at the time of light emission and breaks. When diodes are connected in parallel, the large current can be dispersed, whereby the diodes can be restrained from raising temperature in excess.

### RELATED APPLICATION

This is a continuation-in-part application of application serial no. PCT/JP00/01581 filed on Mar. 15, 2000, now pending.

### BACKGROUND OF THE INVENTION

1. Field of the Invention

The present invention relates to a xenon flash light source apparatus, a socket for a xenon flash light source apparatus, and a rectifier apparatus.

2. Related Background Art

Xenon flash light source apparatus have conventionally been utilized as a light source for spectral analyzing devices, light emission analyzing devices, and the like, and for strobe light sources or high-quality image processing light sources.

A xenon flash light source apparatus comprises a light-emitting section constituted by a lamp and a power supply circuit, a triggerpower section, a cover for covering the trigger power section, and a main power section. The lamp is provided with a cathode and an anode which oppose each other. A trigger probe is disposed between the cathode and anode. A sparker is disposed near the cathode.

When a trigger voltage pulse is applied to the trigger probe and sparker from the main power supply while in a state where a predetermined voltage is applied between the cathode and anode from the main power, a discharge occurs in the trigger probe, along which a main discharge of arc occurs between the cathode and anode. If the trigger voltage pulse flows into the main power section upon light emission, the lamp may fail to emit light correctly or may suffer a breakdown. For preventing this from happening, a diode is connected to the circuit between the main power section and the light-emitting section.

### SUMMARY OF THE INVENTION

Since a large current of 400 A flows through the power supply line from the main power section to the lamp of the xenon flash light source apparatus in order to make the lamp emit light, however, the diode generates heat, thereby raising temperature. Namely, a metal material connected to a semiconductor material is also used in the diode as its constituent. When the current flowing through the diode is small, the heat generation due to the resistance of the metal material is very low if any, so that it is negligible. In the case where a current as large as 400 A flows, however, the resistance value cannot be neglected, whereby heat is generated.

Since the resistance value of the metal material is further raised by the heat generation, the temperature rises further more, whereby the temperature of the whole diode (package) rises, and the permissible amount of current in the diode decreases. Since the diode provided in the power supply line is accommodated in a small-size socket, the cooling of the heated diode is not easy, whereby the heat generated by the diode may cause other circuit components accommodated within the socket to break. When the xenon flash light source apparatus is used continuously, the diode itself may break.

Therefore, it is an object of the present invention to provide a xenon flash light source apparatus and a socket for a xenon flashlight source apparatus which are configured so as to suppress the temperature rise caused by the heat generated by the diode.

The xenon flash light source apparatus in accordance with the present invention comprises a light-emitting section in which an anode, a cathode, and a trigger probe are incorporated within a container filled with xenon gas; a main power section for applying a voltage to the anode and the cathode; a trigger power section for applying a trigger voltage for controlling a light emission timing to the trigger probe; and a rectifier circuit connected to a power supply line between the main power section and the light-emitting section such that a current flows from the main power section to the light-emitting section in a forward direction; wherein the rectifier circuit is constituted by at least two diodes connected in parallel.

In the case where diodes are used in parallel as such, due to differences in characteristics of the diodes, the current flows through one of the diodes at the point of time when the current starts flowing. This diode generates heat as the current flows therethrough, thereby enhancing its resistance. If the resistance becomes identical to or greater than the resistance value of another diode, the current will flow through the latter diode as well. When a large amount of current flows through the diodes connected in parallel as in the present invention, the resistance value of diodes changes greatly due to the heat generation, whereby the amount of current is automatically adjusted between the diodes connected in parallel, so that the current is dispersed into the individual diodes.

The xenon flash light source apparatus may be characterized in that, in at least one of parallel lines provided with the diodes, at least two diodes are connected in series. When diodes are connected in series as such, the voltage applied per diode can be lowered.

The socket for a xenon flash light source in accordance with the present invention is used as being attached to a lamp incorporating an anode, a cathode, and a trigger probe within a container filled with xenon gas and including therein a power supply circuit for applying a voltage supplied from a main power section and a trigger power section to the lamp; wherein the power supply circuit is connected to a first terminal portion electrically connected to the anode, the cathode, and the trigger probe, a second terminal portion electrically connected to the main power section, and a third terminal portion electrically connected to the trigger power section, and has a rectifier circuit connected to a power supply line between the second terminal portion and the first terminal portion such that a current flows from the second terminal portion to the first terminal portion in a forward direction, the rectifier circuit being constituted by at least two diodes connected in parallel. When the rectifier circuit is constituted by diodes used in parallel, the current flowing through the rectifier circuit can easily be dispersed. Also, since the diodes can be restrained from generating heat, the rectifier circuit can be accommodated within the socket.

The socket for a xenon flash light source apparatus may be characterized in that, in at least one of parallel lines provided with the diodes, at least two diodes may be connected in series. When diodes are connected in series as such, the voltage applied per diode can be lowered.

### BRIEF DESCRIPTION OF THE DRAWING

FIG. 1 is a diagram showing the configuration of a power circuit of the xenon flash light source apparatus in accordance with an embodiment;

FIG. 2 is a plan view of a lamp seen from the light projection window side;

FIG. 3 is a view showing the rectifier circuit in accordance with the embodiment; and

FIG. 4 is an exploded perspective view of the light-emitting section of the xenon flash light source apparatus.

### DESCRIPTION OF THE PREFERRED EMBODIMENT

A preferred embodiment of the xenon flash lamp in accordance with the present invention will be explained with reference to the drawings. In the explanation of the drawings, constituents identical to each other will be referred to with numerals or letters identical to each other without repeating their overlapping descriptions.

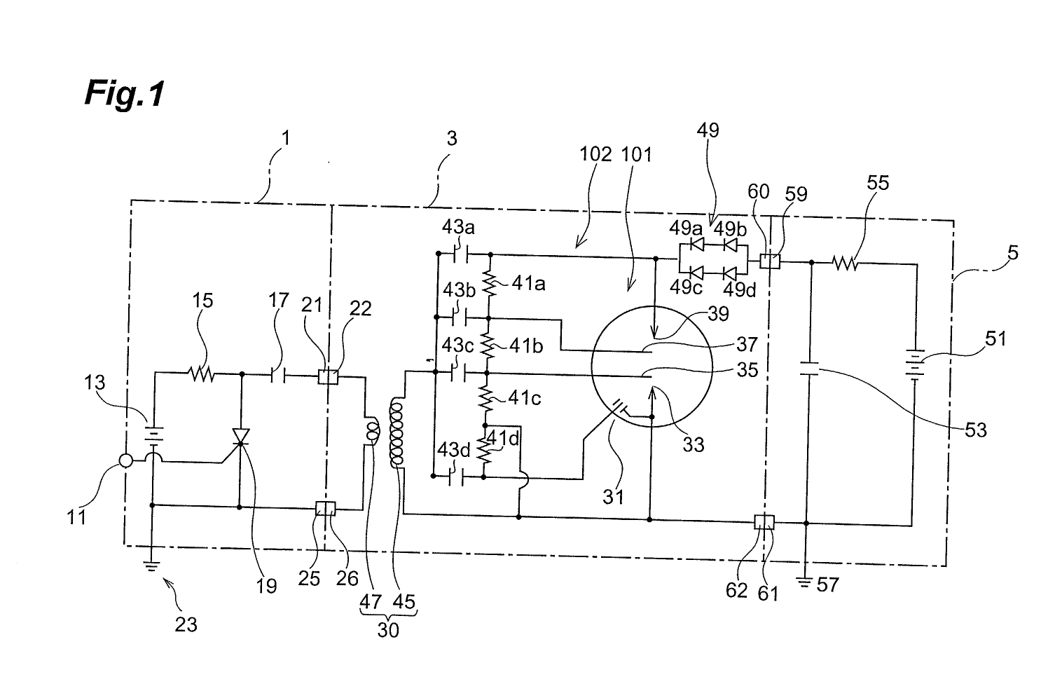

FIG. 1 is a diagram showing the circuit configuration of the power supply of a xenon flash light source apparatus. The xenon flash light source apparatus is constituted by a light-emitting section 3 having an anode 39 and a cathode 33; a main power section 5 for applying a voltage to the anode 39 and cathode 33 within the light-emitting section 3; and a trigger power section for applying a trigger voltage for controlling the light emission timing to trigger probes 35, 37; whereas the individual parts are connected to each other by input/output terminals. The light-emitting section 3 is constituted by a lamp 101 and a power supply circuit 102.

The trigger power section 1 will now be explained. The trigger power section 1 incorporates therein a trigger power 13 for applying the trigger voltage. A resistor 15 and a trigger capacitor 17 are connected in series between the “+” terminal of the triggerpower 13 and an output terminal 21 connected to the light-emitting section 3. The junction between the resistor 15 and trigger capacitor 17 and the “−” terminal of the trigger power 13 are connected to each other by way of a thyristor 19 which functions as a switch according to the trigger signal fed from an input terminal

The main power section 5 will now be explained. A resistor 55 is connected between the “+” terminal of a main discharge power 51 for applying a voltage to the anode 39 and cathode 33 of the light-emitting section 3 and an output terminal 59 connected to the light-emitting section 3, whereas the “−” terminal of the main discharge power 51 is grounded and acts as an input terminal 61 connected to the light-emitting section 3. A main capacitor 53 is connected between the junction between the resistor 55 and output terminal 59 and the main discharge power 51. Here, the main capacitor 53 is provided for supplying a large amount of current to the light-emitting section 3 instantaneously.

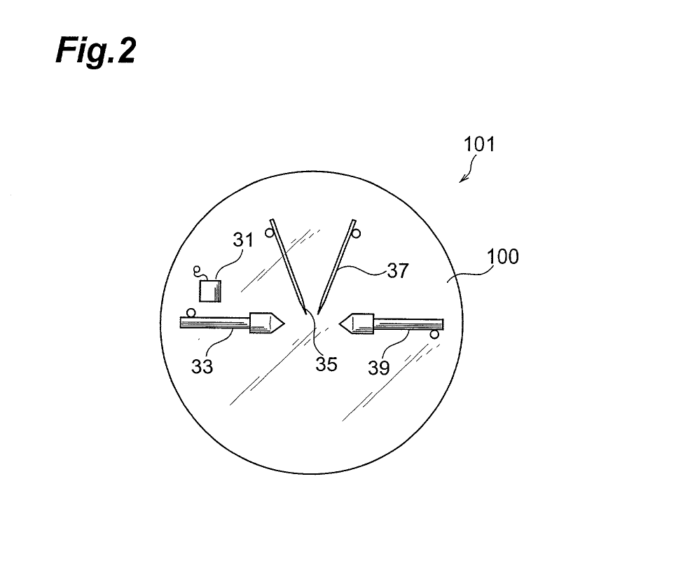

The light-emitting section 3 will now be explained with reference to FIGS. 1 and 2. First, the outline of the lamp 101 will be explained with reference to FIG. 2. FIG. 2 is a view of the lamp 101 as seen from the side of a light projection window 100. The anode 39 and the cathode 33 are disposed so as to oppose each other with a predetermined gap therebetween, whereas the trigger probes 37 and 35 are provided therebetween. Also, a sparker 31 is disposed near the cathode 33. Here, the trigger probes 35 and 37 are electrodes for a preliminary discharge which functions to generate a main discharge of the xenon flash lamp stably and easily, whereas the sparker 31 is an electrode which functions to stably generate a discharge of the xenon flash lamp each time.

Though two trigger probes are provided in this embodiment, the number of trigger probes varies depending on the electrode gap between the anode 39 and the cathode 33. For example, one trigger probe and five trigger probes are provided when the electrode gap is 1.5 mm and 8 mm, respectively.

Referring to FIG. 1 again, the circuit configuration of the light-emitting section 3 will be explained. A trigger transformer 30 for amplifying the voltage from the trigger power section is formed by opposing coils 47 and 45 connected between the input terminal 22 and the output terminal 26. The input terminal 22 is connected to the output terminal 21 of the trigger power section, whereas the output terminal 26 is connected to the input terminal 25 of the trigger power section 1. One end of the coil 45 is connected to capacitors 43a to 43d. The capacitor 43a is connected to an input terminal 60 which is connected to the anode 39 and main power section 5. The capacitor 43b is connected to the trigger probe 37. The capacitor 43c is connected to the trigger probe 35. The capacitor 43d is connected to the sparker 31. The anode 39 and the trigger probe 37 are connected to each other by a resistor 41a. The trigger probes 37 and 35 are connected to each other by a resistor 41b. The trigger probe 35 and the sparker 31 are connected to each other by resistors 41c and 41d. The junction between the resistors 41c and 41d is connected to the other end of the coil 45.

A rectifier circuit 49, which is a characteristic feature of this embodiment, is disposed between the input terminal 60 and the anode 39. The rectifier circuit 49 is connected such that the current flowing from the main power section 5 to the light-emitting section 3 is in the forward direction. The rectifier circuit 49 is constituted by four diodes 49a to 49d. The diodes 49a and 49b are connected in series, whereas the diodes 49c and 49d are connected in series. A circuit having the diodes 49a and 49b and a circuit having the diodes 49c and 49d are connected in parallel.

In other words, the light source apparatus comprises rectifier circuit 49 supplying an electric power to the lamp 101 thereof, said rectifier circuit comprising first and second diodes 49a, 49c (49b, 49d) arranged physically close to each other and connected in parallel.

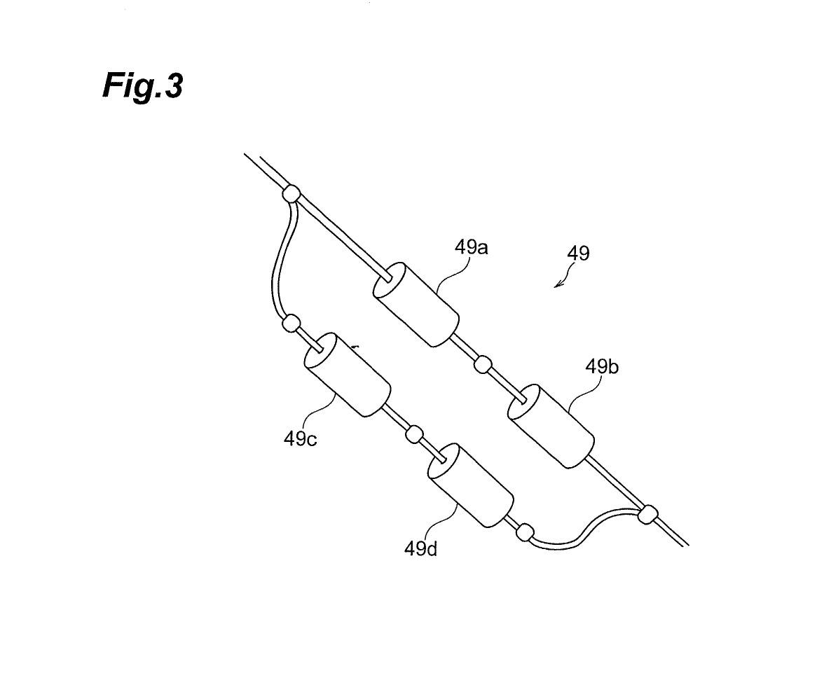

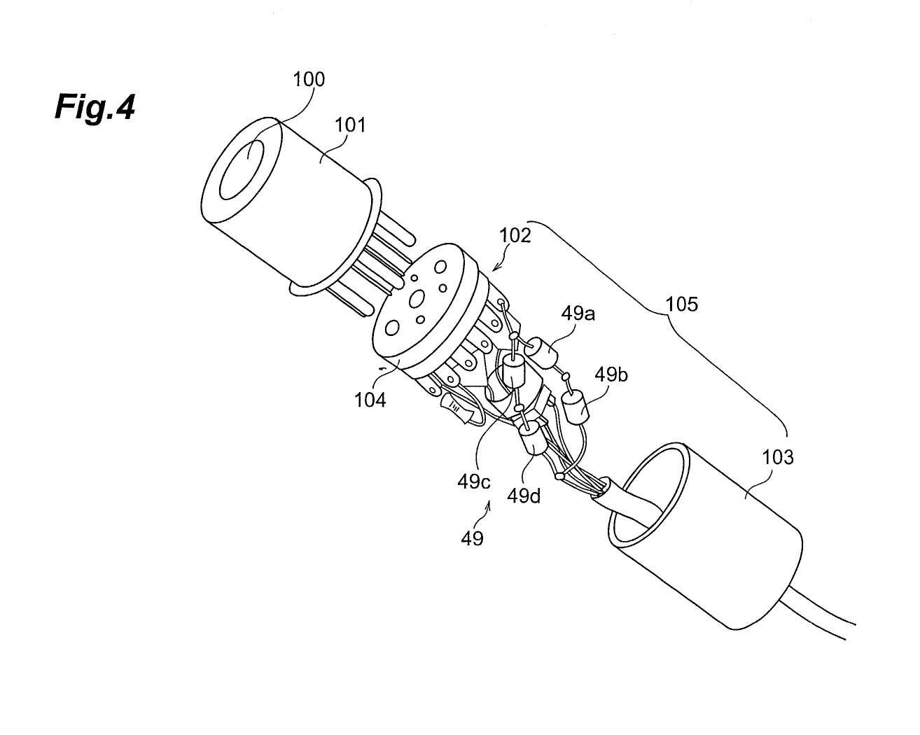

With reference to FIGS. 3 and 4, the rectifier circuit 49, which is a characteristic feature of this embodiment, will be explained. FIG. 3 is a view showing the rectifier circuit 49 in this embodiment, whereas FIG. 4 is an exploded perspective view of the light-emitting section 3 in the xenon flash light source apparatus. As shown in FIG. 3, the rectifier circuit 49 is constituted by the diodes 49a to 49d connected by soldering. Though the use of a single diode tolerant of a large current may be considered, such a diode is expensive. A configuration such as that of this embodiment can easily prevent diodes from generating heat, thus achieving the object of the present invention. Since the rectifier circuit 49 is configured so as to suppress the heat generated by the current, it can be accommodated within a socket 105 constituted by a lamp connection terminal portion 104 and a cover 103 as shown in FIG. 4. The rectifier circuit 49 and the socket 105 constitute a rectifier apparatus. In this rectifier apparatus, the rectifier circuit 49 comprising the first and second diodes 49a, 49c (49b, 49d) arranged physically close to each other (within 2 cm) and connected in parallel are accommodated within the socket 105. The respective current-voltage characteristics of the first and second diodes 49a, 49c slightly differ from each other due to their individual differences.

Operations of the xenon flash lamp in this embodiment will now be explained. First, the main power 51 applies a predetermined voltage to the anode 39 and cathode 33, and charges the main capacitor 53. When a trigger signal is fed into the trigger power section 1 from the terminal 11, on the other hand, the thyristor 19 is turned ON, whereby the electric charge accumulated in the trigger capacitor 17 is outputted. As a consequence, a pulse voltage of 100 to 300 V is applied to the coil 47 of the trigger transformer 30 in the light-emitting section 3. Subsequently, the pulse voltage is amplified by the trigger transformer 30, so that the coil 45 generates a pulse voltage of 5 to 7 kV, which is applied to the sparker 31, trigger probes 35, 37, and Haanode 39 within the lamp 101. At this time, the rectifier circuit 49 can prevent the pulse current from flowing toward the main power section 5.

The discharging phenomenon in the lamp will now be explained. First, a preliminary discharge of the sparker 31 occurs, and then a preliminary discharge between the cathode 33 and the trigger probe 35, and a preliminary discharge between the trigger probes 35 and 37 occur in succession, thereby forming a preliminary discharge path. Immediately thereafter, a main discharge between the anode 39 and cathode 33 occurs along the preliminary discharge path, thereby generating arc light emission. When the discharge between the anode 39 and cathode 33 occurs, the electric charge accumulated in the main capacitor 53 is outputted together with the current caused by the main power 51, whereby the current passing through the rectifier circuit 49 flows from the main capacitor 53 toward the anode 39.

In the xenon flash lamp, the current flowing from the main power section 5 to the light-emitting section 3 has a large amount, so that the rectifier circuit 49 is likely to generate heat, thereby raising the temperature of the rectifier circuit 49. When the diodes 49a to 49d are used in parallel as the rectifier circuit 49a as in this embodiment, due to differences in their characteristics, a current flows through one of the circuits at the time when the current starts flowing. For example, when the current flows through the circuit having the diodes 49a and 49b and generates heat such that the internal resistance of the diodes increases to a value identical to or higher than the resistance of the circuit having the diodes 49c and 49d, the current also flows through the circuit having the diodes 49c and 49d, thereby suppressing the amount of current in the circuit having the diodes 49a and 49b.

In the case where a large amount of current flows through diodes connected in parallel as in this embodiment, the resistance value of diodes greatly changes due to their heat generation, so that the amount of current is automatically adjusted between the diodes connected in parallel, whereby the current is dispersed into the individual diodes. Therefore, the current does not flow through one circuit alone in a concentrated manner and raise the temperature of diodes constituting the circuit, whereby the rectifier circuit can be prevented from breaking due to the heat generation.

Though two diodes are connected in series in each of parallel lines in this embodiment, one diode may be used in each of the parallel lines.

Though an embodiment of the xenon flash light source apparatus in accordance with the present invention is explained in detail in the foregoing, the present invention is not restricted to the above-mentioned embodiment. For example, diodes connected to the power supply line may also be provided in three or more parallel lines instead of two parallel lines.

In the present invention, the rectifier circuit is ad connected to the power supply line from the main power section in order to prevent the pulse voltage for controlling the light emission timing from being applied to the main power section. Since the rectifier circuit is constituted such that diodes are connected in parallel, the current flowing through the power supply line from the main power section to the light-emitting section can be dispersed into the individual diodes connected in parallel, whereby the diodes can be restrained from generating heat and raising temperature. As a consequence, the diodes can be prevented from breaking due to the heat generation.

The xenon flash light source apparatus equipped with the above-mentioned xenon flash lamp can be utilized in light sources for spectral analysis, light emission analysis, and the like, strobe light sources, high-quality image processing light sources, or the like.

What is claimed is:

1. A xenon flash light source apparatus comprising:
a light-emitting section having a lamp in which an anode, a cathode, and a trigger probe are incorporated within a container filled with xenon gas;
a main power section for applying a voltage to said anode and said cathode;
a trigger power section for applying a trigger voltage for controlling a light emission timing to said trigger probe; and
a rectifier circuit connected to a power supply line between said main power section and said lamp such that a current flows from said main power section to said light-emitting section in a forward direction, wherein said rectifier circuit is constituted by at least two diodes connected in parallel.

2. A xenon flash light source apparatus according to claim 1, wherein, in at least one of parallel lines provided with said diodes, at least two diodes are connected in series.

3. A socket for a xenon flash light source apparatus, said socket being used as being attached to a lamp incorporating an anode, a cathode, and a trigger probe within a container filled with xenon gas, said socket including therein a power supply circuit for applying a voltage supplied from a main power section and a trigger power section to said lamp; wherein said power supply circuit is connected to a first terminal portion electrically connected to said anode, said cathode, and said trigger probe, a second terminal portion electrically connected to said main power section, and a third terminal portion electrically connected to said trigger power section, and has a rectifier circuit connected to a power supply line between said second terminal portion and said first terminal portion such that a current flows from said second terminal portion to said first terminal portion in a forward direction, said rectifier circuit being constituted by at least two diodes connected in parallel.

4. A socket for a xenon flashlight source apparatus according to claim 3, wherein, in at least one of parallel lines provided with said diodes, at least two diodes are connected in series.

5. A rectifier apparatus comprising a rectifier circuit accommodated within a socket, said rectifier circuit comprising first and second diodes arranged physically close to each other and connected in parallel.

6. A light source apparatus comprising a rectifier circuit supplying an electric power to a lamp, said rectifier circuit comprising first and second diodes arranged physically close to each other and connected in parallel.
